(19) United States
(12) Patent Application Publication
(10) Pub. No.: US 2018/0250534 A1
(43) Pub. Date: Sep. 6, 2018

(54) DEVICE FOR BREAKING A VEHICLE WINDOW IN AN EMERGENCY SITUATION

(71) Applicant: Evelynn K. Riley, Centreville, MI (US)

(72) Inventor: Evelynn K. Riley, Centreville, MI (US)

(21) Appl. No.: 15/909,768

(22) Filed: Mar. 1, 2018

Related U.S. Application Data
(60) Provisional application No. 62/465,870, filed on Mar. 2, 2017.

(51) Int. Cl. A62B 3/00; A44B 11/25

(52) U.S. Cl. CPC A62B 3/005; A44B 11/2546

(57) ABSTRACT

A device for breaking a vehicle window includes a seat belt buckle that has a metallic clasp-engaging portion and a plastic belt-engaging portion. A retractable breaking member is disposed at the belt-engaging portion and is configured to be movable from a stored position that conceals a tip of the breaking member within the belt-engaging portion to an extended position that exposes the tip of the breaking member.

### CROSS-REFERENCE TO RELATED APPLICATION

This application claims benefit and priority under 35 U.S.C. § 119(e) of U.S. provisional application Ser. No. 62/465,870, filed Mar. 2, 2017, which is hereby incorporated herein by reference in its entirety.

### FIELD OF THE INVENTION

The present invention generally relates to a device configured for breaking a vehicle window, and more particularly to a device that is readily accessible by a driver of a vehicle to break a glass window in an emergency situation, such as upon the vehicle being submerged.

### BACKGROUND OF THE INVENTION

It is generally known that vehicle doors can be difficult or in some cases impossible for an occupant to open when a vehicle is submerged in water, such as in an emergency following a collision. Accordingly, when other vehicle exit routes are blocked or difficult to locate, it can be advantageous for an occupant to break a window of the vehicle to escape the submerged vehicle in such an emergency situation. However, vehicle windows can be difficult to break by hitting the window with blunt objects, such as with the use of hands, feet, or the like. This difficulty is increased especially when a vehicle is submerged and inward pressure from the water is exerted on the doors and windows.

### SUMMARY OF THE PRESENT INVENTION

The present invention provides a device for breaking a vehicle window, such as a door window or windshield or the like, where the device has a breaking tip that is incorporated into a seat belt buckle and is generally concealed during normal use of the seat belt buckle to prevent the cause of unintentional injuries or damage to the vehicle, such as puncturing or scratching seats or interior trim, from the exposed breaking tip. The device, thus, includes a seat belt buckle that has a metallic clasp-engaging portion and a plastic belt-engaging portion, where the plastic belt-engaging portion includes a breaking member that is movable from a stored or idle position that conceals a tip of the breaking member within the plastic portion of the seat belt buckle to an extended position that exposes the tip of the breaking member. The breaking member may be spring loaded to forcefully move the tip to the extended position, such that the device may be held against the vehicle window prior to the spring loaded movement to break the glass. The breaking member may also or alternatively be locked or held in the extend position, such that a user can easily grasp the seat belt buckle and forcibly hit or contact the tip of the breaking member against a vehicle window to facilitate breaking the glass in an emergency situation.

According to one aspect of the present invention, a device for breaking a vehicle window includes a seat belt buckle having a metallic clasp-engaging portion and a plastic belt-engaging portion. A retractable breaking member is disposed at the belt-engaging portion and is configured to be movable, such as via a slider, from a stored position that conceals a tip of the breaking member within the belt-engaging portion to an extended position that exposes the tip of the breaking member. The breaking member may be configured to lock in the extend position, such that a user can easily grasp the seat belt buckle and forcibly contact the tip of the breaking member, such as a carbide or ceramic tip, against a vehicle window to facilitate breaking the glass. Further, the breaking member may comprises an elongated shaft that is disposed in generally parallel alignment with a lateral slot that extends through belt-engaging portion for receiving a seat belt strap.

According to another aspect of the present invention, a method provides a seat belt buckle that has a clasp-engaging portion attached to a plastic belt-engaging portion, which has a lateral slot for holding the seat belt buckle on a seat belt strap. A retractable breaking member disposed at the belt-engaging portion is moved from a stored position concealing a tip of the breaking member within the belt-engaging portion to an extended position that exposes the tip of the breaking member. The retractable breaking member is locked in the extend position, such that a user can easily grasp the seat belt buckle and forcibly contact the tip of the breaking member against a vehicle window to facilitate breaking the glass.

These and other objects, advantages, purposes, and features of the present invention will become apparent upon review of the following specification in conjunction with the drawings.

### BRIEF DESCRIPTION OF THE DRAWINGS

FIG. 1 is a front elevation view of a window breaking device having a breaking member integrated in a seat belt buckle;

FIG. 2 is a side elevation view of the window breaking device shown in FIG. 1;

FIG. 3 is a front elevation view of the window breaking device shown in FIG. 1, showing the breaking member in an idle position;

FIG. 3A is an enlarged section of the front elevation view of the window breaking device taken at section A of FIG. 3;

FIG. 4 is a front elevation view of the window breaking device shown in FIG. 1, showing the breaking member in a compressed position;

FIG. 4A is an enlarged section of the front elevation view of the window breaking device taken at section A of FIG. 4;

FIG. 5 is a front elevation view of the window breaking device shown in FIG. 1, showing the breaking member in an extended position;

FIG. 5A is an enlarged section of the front elevation view of the window breaking device taken at section A of FIG. 5;

FIG. 6 is a front elevation view of an additional embodiment of a window breaking device, showing a breaking member in the extended position in dashed lines; and

FIG. 7 is a side elevation view of the window breaking device shown in FIG. 6.

### DETAILED DESCRIPTION OF EMBODIMENTS

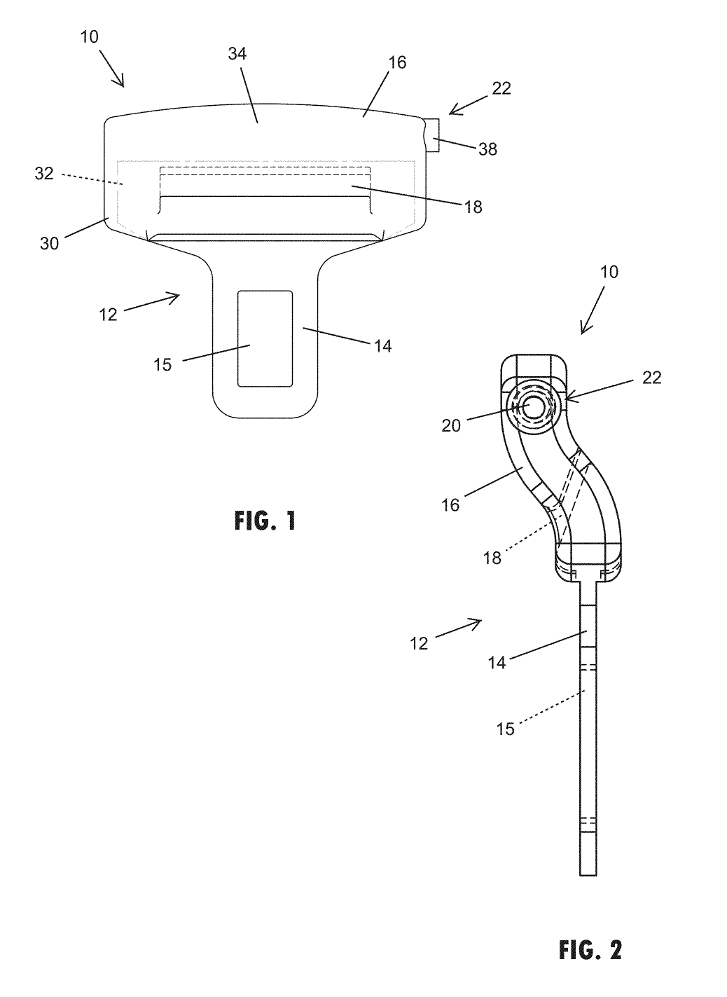

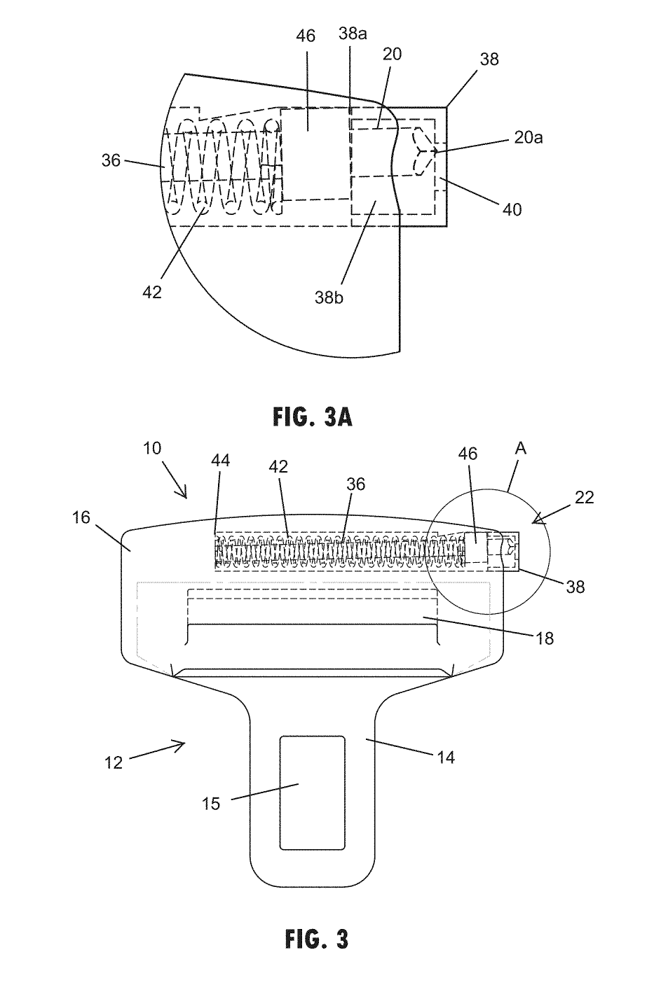

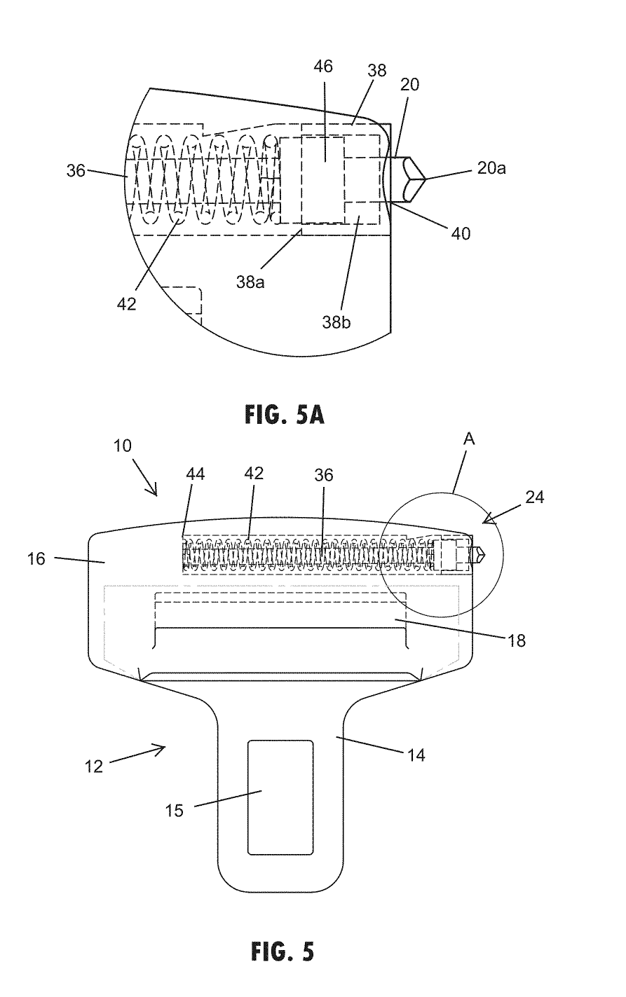

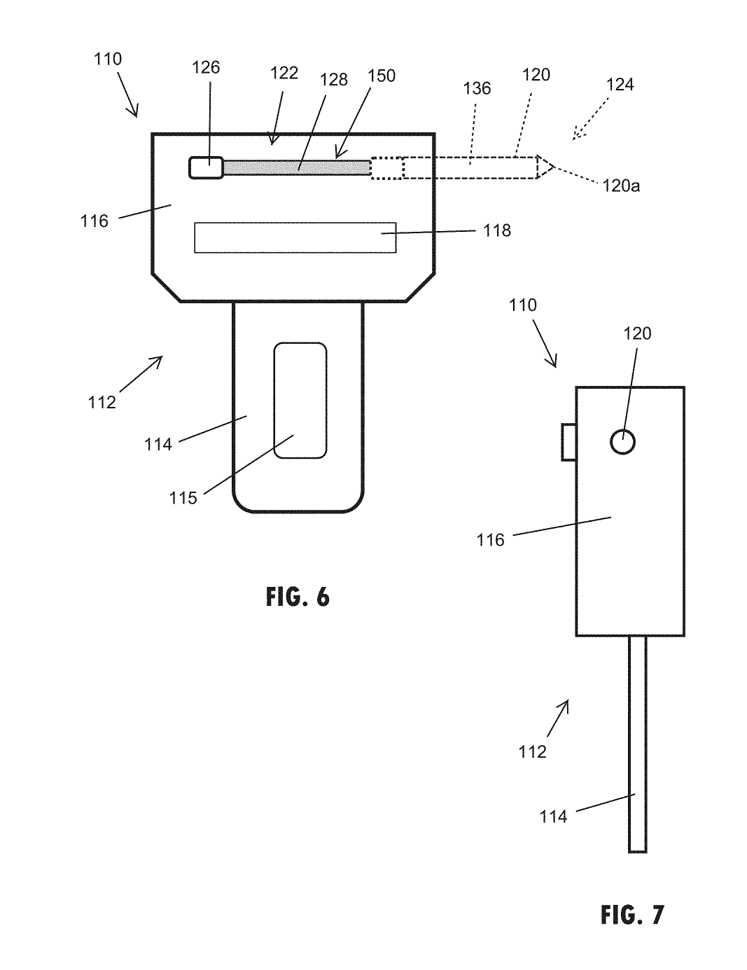

Referring now to the drawings and the illustrative embodiments depicted therein, a window breaking device 10, 110 is provided for breaking a vehicle window, such as a door window or windshield or the like, during an emergency situation, such as upon or during submersion of a vehicle in water. The window breaking device 10, such as show in FIGS. 1-5, includes a seat belt buckle 12 that has a shank or metallic clasp-engaging portion 14 and a handle or plastic belt-engaging portion 16 with a slot 18 for receiving a seat belt strap. A retractable breaking member 20 is disposed at the belt-engaging portion 16 in a manner that allows the breaking member 20 to be movable between an idle or stored position 22 (FIG. 3) that conceals a tip 20a of the breaking member 20 within the belt-engaging portion 16 and an exposed position 24 (FIG. 5A) that exposes the tip 20a of the breaking member 20 and allows the tip 20a of the breaking member 20 to contact a vehicle window to facilitate breaking the glass. To expose the breaking member 20 in one embodiment, as shown in FIGS. 1-5A, the breaking member 20 may be spring loaded to forcefully move the tip 20a to the extended position 24, as further described below. In an additional embodiment of the window breaking device 110, the breaking member 120 may also or alternatively be locked or held in the extend position 124, such shown in FIGS. 6 and 7, where a user can grasp the seat belt buckle and forcibly hit or contact the tip 120a of the breaking member 120 against a vehicle window to facilitate breaking the glass in an emergency situation.

As shown in FIGS. 1 and 2, the seat belt buckle 12 may have a metallic engagement portion 14 with an opening 15 for engaging a buckle clasp and a plastic gasping portion 16 molded over or otherwise attached to the engagement portion 14 to provide an area for a user to hold the buckle when inserting it into a buckle clasp. The plastic grasping portion 16 may also have a lateral slot 18 for receiving a seat belt strap, such that the buckle 12 cannot be removed from the strap without disassembling the associated belt assembly, which is typically concealed by vehicle interior trim. By integrating or incorporating the seat belt buckle 12 into the window breaking device 10, the user will be able to easily access the device 10, as often the first step often taken by someone in an emergency situation, such as submersion of a vehicle, is to remove the seat belt, such that the seat belt buck 12 may be the first object the occupant will be holding in such a situation. Thus, the occupant will not be forced to locate a separate object or tool somewhere in the vehicle, presuming such an object or tool may be accessible or available.

With further reference to FIGS. 1 and 2, the slot 18 for receiving a seat belt strap may extend through both the clasp-engaging portion 14 and the belt-engaging portion 16 of the seat belt buck 12, such that the single metal piece that forms the clasp-engaging portion 14 may transmit forces form the seatbelt that is received at the slot 18 are directly transmitted to the buckle clasp engaged at the opening 15. A lower portion 30 of the plastic belt-engaging portion 16 may thus conceal an upper portion 32 of the metal piece that forms the clasp-engaging portion 14 such as shown in FIG. 1. The over molded plastic piece that form illustrated belt-engaging portion 16 also has an upper portion 34 located above the upper portion 32 of the metal piece that forms the clasp-engaging portion 14, where the upper portion 34 at least partially conceals the breaking member 20 and forms the housing or surround structure that at least partially contains the breaking member 20.

The retractable breaking member 20, as shown in FIGS. 3 and 3A, is disposed at or movably engaged within the plastic, belt-engaging portion 16 of the seat belt buckle 12. The breaking member 20 has an elongated shaft 36 that may be disposed or arranged in parallel alignment or slightly offset from the lateral slot 18 that receives the seatbelt strap. As such, the breaking member 20 may not interfere structurally or functionally with the seatbelt strap or the metallic, clasp portion 14 of the seat belt buckle 12. The tip portion 20a of the breaking member 20 may be further concealed by a cap 38, such as shown in FIGS. 1-3. The cap 38 includes a central opening 40 (FIG. 3A) that is sized to allow at least the tip portion 20a of the breaking member to exit the housing formed by the belt-engaging portion 16 of the seat belt buckle 12, such as further shown and described herein.

For the breaking member to move from the idle or retracted position 22 (FIG. 3) to the extended position 24 (FIG. 5), there may be various means to expose the tip portion 20a of the breaking member 20 to facilitate breaking the window. In the embodiment shown in FIGS. 1-5A, the breaking member 20 is spring loaded to allow the tip portion 20a to forcefully move, at least from the force transmitted of a spring 42, to the extended position 24. The spring 42 may be a helical compression spring that is disposed around the elongated shaft 36 of the breaking member 20. As shown in FIGS. 3 and 3A, the compression spring 42 may extend between a base surface 44 of the interior channel provided in the belt-engaging portion 16 of the seat belt buckle 12 and a spring compression member 46 that is in fixed engagement with an outer portion of the elongated shaft 36, near or adjacent to the tip portion 20a.

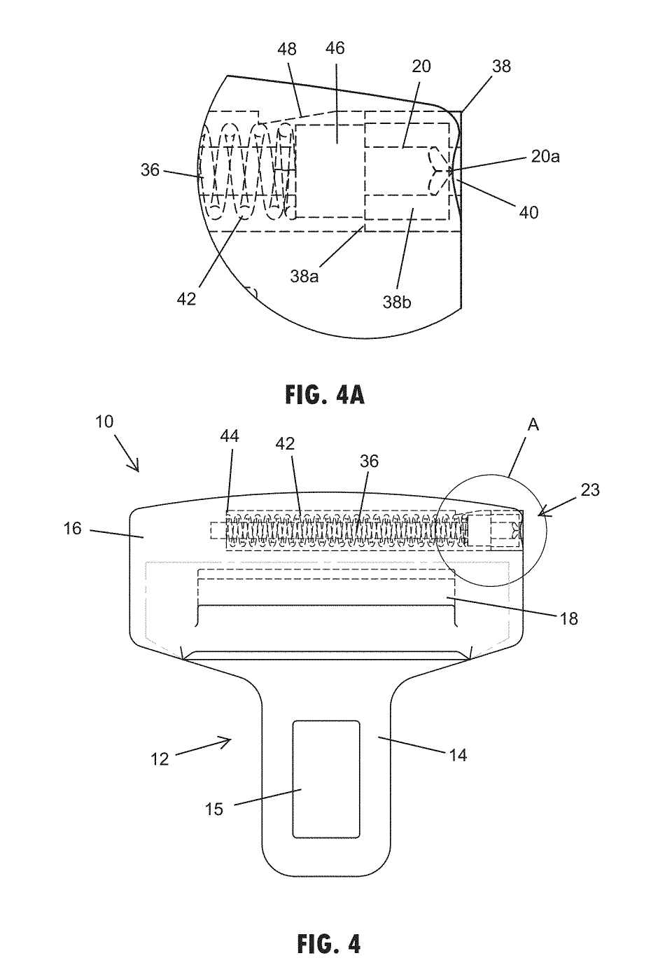

The edge 38a of the cap 38 is in abutting contact with the compression member 46, such that the window breaking device 10 may be held with the cap 38 in contact against a vehicle window and pressed toward the window to move the breaking member 20 toward the compressed position 23, as shown in FIGS. 4 and 4A. Upon pressure being exerted on the cap 38, compression member 46 is moved inward to compress the spring 42, while also moving the breaking member 20 inward further into the belt-engaging portion 16 of the seat belt buckle 12. During this inward movement, as shown in FIG. 4A, the compression member 46 may slide along an inclined or ramped surface 48 disposed along the inside of the channel within the belt-engaging portion 16, which causes the compression member 46 to move relative to the edge 38a of the cap 38. As the pressure of the cap 38 against the window increases, the spring compression also increase to the compressed position 23 shown in FIG. 4.

The built up spring compression acting on the breaking member 20 is released when the compression member 46 eventually moves off of and out contact with the edge 38a of the cap 38, so as to allow the compression member to move into an recessed area 38b (FIG. 4A) of the cap 38, which also causes the tip portion 20a to forcefully move outward and through the hole 40 in the cap 39 to the extended position 24, as shown in FIGS. 5 and 5A. With the belt-engaging portion 16 of the seat belt buckle 12 still near or in contact with the widow, this forceful outward movement of the tip portion 20a causes the tip portion 20a to contact the window and the spring loaded force driving the breaking member 20 to break the glass.

The movable engagement of the breaking member 20 may be facilitated by the breaking member 20 being coupled with a slider that is disposed on the belt-engaging portion 16. The slider is configured for a user to move the breaking member 20 between the stored and extended positions 22, 24. It is contemplated that the slider may include a spring or biasing element to urge or otherwise bias the breaking member 20 in one of the positions, such as in the retracted position or stored position 22 to prevent unintentional release or movement of the breaking member 20 to the extending position 24. It is contemplated that the specific shapes and features shown in FIGS. 1-5A that provide the spring-loaded breaking force may be altered in additional embodiments within the scope of the present disclosure.

In an additional embodiment shown in FIGS. 6 and 7, the window breaking device 110 includes a breaking member 120 that is disposed at or movably engaged within the plastic, belt-engaging portion 116 of the seat belt buckle 112. The breaking member 120 has an elongated shaft 136 that may be disposed or arranged in generally parallel alignment with the lateral slot 118 that receives the seatbelt strap. As such, the breaking member 120 may not interfere structurally or functionally with the seatbelt strap or the metallic, clasp portion 114 of the seat belt buckle 112.

For the breaking member 120 to move from the idle or retracted position 122 to the extended position 124, such as shown in FIG. 6, a slider 150 may be provided to manually move the breaking member may comprise a tab 126 that extends from breaking member 120 through an open channel 128, such that the user can move the tab 126 along the open channel 128 to correspondingly move the breaking member 120. The open channel 128 may have a generally circular cross section, as shown in FIG. 7, with a narrower opening that extends along an upper portion of the circular cross-section to allow the tab 126 to extend through and move along the channel 128. The slider may also have a catch or lock feature that allows the breaking member to lock or be held in a desired position, such as in the extended position 124 for the user to grasp the seat belt buckle and forcibly contact the tip 120a of the breaking member 120 against a vehicle window to break the glass of the window. The tip of the breaking member may include a point that comprises a metal, carbide, or ceramic or other hardened material known to easily break glass, such that even small amounts of force can be applied to the break the glass of the window. Also, the tip may be shaped as a chamfered point, such as shown in FIGS. 2-5A, or a conical point, such as shown in FIG. 6. It is also contemplated that the tip in additional embodiments may have alternative shapes that are configured to effectively break glass that is pressurized by water at the exterior surface.

The corresponding method of using the window breaking device includes providing a seat belt buckle with a clasp-engaging portion that is attached to a plastic belt-engaging portion. The clasp-engaging portion has an opening for engaging a buckle clasp and the belt-engaging portion has a lateral slot for holding the seat belt buckle on a seat belt strap. A retractable breaking member is disposed at the belt-engaging portion and is moved from a stored position concealing a tip of the breaking member within the belt-engaging portion to an extended position that exposes the tip of the breaking member. The retractable breaking member may then lock in a desired extend position for use.

Thus, in accordance with the present invention, the device has a breaking tip that is incorporated into a seat belt buckle and is generally concealed during normal use of the seat belt buckle to prevent the cause of unintentional injuries or damage to the vehicle, such as puncturing or scratching seats or interior trim, from the exposed breaking tip. The device conceals the tip of the breaking member by housing it in a channel formed in the plastic portion of a seat belt buckle. The breaking member may also be configured to lock or be held in an extend position, such that a user can easily grasp the seat belt buckle and forcibly hit or contact the tip of the breaking member against a vehicle window to facilitate breaking the glass, such as in an emergency situation

For purposes of this disclosure, it is to be understood that the invention may assume various alternative orientations, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A device for breaking a vehicle window, said device comprising:
a seat belt buckle having a metallic clasp-engaging portion and a plastic belt-engaging portion, wherein the belt-engaging portion has a lateral slot for receiving a seat belt strap; and
a retractable breaking member disposed at the belt-engaging portion and configured to be movable from a stored position that conceals a tip of the breaking member within the belt-engaging portion to an extended position that exposes the tip of the breaking member.

2. The device of claim 1, further comprising a spring disposed between the breaking member and the seat belt buckle that is configured to bias the breaking member toward the extended position, wherein the retractable breaking member is configured to release from the stored position to the extended position to contact the tip of the breaking member against a vehicle window under the biasing force of the spring to facilitate breaking glass of the window.

3. The device of claim 1, wherein the breaking member is configured to lock in the extend position, such that a user can easily grasp the seat belt buckle and forcibly contact the tip of the breaking member against a vehicle window to facilitate breaking glass of the window. The device of claim 1, wherein the breaking member comprises an elongated shaft that is disposed in an interior channel of the belt-engaging portion that does not interfere with the lateral slot in the belt-engaging portion of the seat belt buckle.

5. The device of claim 1, wherein the breaking member is coupled with a slider disposed on the belt-engaging portion and configured for a user to move the breaking member between the stored and extended positions.

6. The device of claim 1, wherein the tip of the breaking member includes a point that comprises at least one of metal, carbide, and ceramic.

7. A window breaking device for breaking a vehicle window, said device comprising:
a seat belt buckle having (i) a shank portion that includes an opening disposed at a lower portion of the shank that is configured for engaging a buckle clasp and (ii) a handle portion disposed over an upper portion of the shank portion for a user to grasp;
wherein a slot extends through the handle portion and the shank portion for receiving a seatbelt strap; and
a breaking member disposed at least partially within the handle portion and configured to be movable from a stored position that conceals a tip of the breaking member within the belt-engaging portion to an extended position that exposes the tip of the breaking member that is used to break the vehicle window.

8. The window breaking device of claim 7, further comprising a spring disposed between the breaking member and the seat belt buckle that is configured to bias the breaking member toward the extended position.

9. The window breaking device of claim 8, wherein the breaking member is configured to be held in the stored position and, upon actuation by the user, released from the stored position to the extended position to contact the tip of the breaking member against the vehicle window under the biasing force of the spring.

10. The window breaking device of claim 7, wherein the breaking member is configured to lock in the extend position, such that the user can easily grasp the seat belt buckle and forcibly contact the tip of the breaking member against the vehicle window.

11. The window breaking device of claim 7, wherein the breaking member comprises an elongated shaft that is disposed in an interior channel of the belt-engaging portion that does not interfere with the lateral slot in the belt-engaging portion of the seat belt buckle.

12. The window breaking device of claim 7, wherein the tip of the breaking member includes a point that comprises one of carbide and ceramic.

13. A method comprising:
providing a seat belt buckle having a clasp-engaging portion attached to a plastic belt-engaging portion that has a lateral slot for holding the seat belt buckle on a seat belt strap;
moving a retractable breaking member disposed at the belt-engaging portion from a stored position concealing a tip of the breaking member within the belt-engaging portion to an extended position that exposes the tip of the breaking member, such that the tip of the breaking member can forcibly contact against a vehicle window to facilitate breaking glass of the window.

14. The method of claim 13, further comprising locking the retractable breaking member in the extend position.

15. The method of claim 13, wherein the breaking member comprises an elongated shaft that is disposed in generally parallel alignment with the lateral slot in the belt-engaging portion of the seat belt buckle.

16. The method of claim 13, wherein the breaking member is coupled with a slider disposed on the belt-engaging portion and configured for a user to move the breaking member between the stored and extended positions.

17. The method of claim 13, wherein the tip of the breaking member includes a point that comprises one of carbide and ceramic.
